(19) United States
(12) Patent Application Publication
(10) Pub. No.: US 2010/0271474 A1
(43) Pub. Date: Oct. 28, 2010

(54) SYSTEM AND METHOD FOR INFORMATION FEEDBACK

(75) Inventors: HOU-HSIEN LEE, Tu-Cheng (TW); CHANG-JUNG LEE, Tu-Cheng (TW); CHIH-PING LO, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/469,652

(22) Filed: May 20, 2009

(30) Foreign Application Priority Data
Apr. 27, 2009 (CN) 200910301882.4

(51) Int. Cl. H04N 7/18; G06K 9/46

(52) U.S. Cl. 348/135; 382/190; 348/E07.085

(57) ABSTRACT

An information feedback system includes a display module, an information acquisition module, a network module, and a processing module. The display module displays media content. The information acquisition module obtains numbers of viewers of the display module at different times in a time period. The processing module receives the numbers of the viewers via the network module, and obtains an accumulated number of the viewers.

### BACKGROUND

1. Technical Field

The present disclosure relates to information gathering systems, and more particularly to an information feedback system and method of an outdoor media.

2. Description of Related Art

In recent years, outdoor media grows vigorously, such as electronic advertisement billboards, which can be set in different kinds of places filled with people, like building entrances, subway stations, and supermarkets. Sometimes, content of the outdoor media could be made more effective if changed according to audience reaction and/or changing demographics. Therefore, a need exists for operators to be able to obtain data from the outdoor media remotely, such as the number of people who are attracted by visual and acoustic effect of the outdoor media, and differences between attitudes toward the media content of different groups, and demographic data such as audience members' ages and gender.

### BRIEF DESCRIPTION OF THE DRAWINGS

FIG. 1 is a block diagram of a first embodiment of an information feedback system.

FIG. 2 is a flowchart view of a first embodiment of an information feedback method.

FIG. 3 is a block diagram of a second embodiment of an information feedback system.

FIG. 4 is a flowchart view of a second embodiment of an information feedback method.

### DETAILED DESCRIPTION

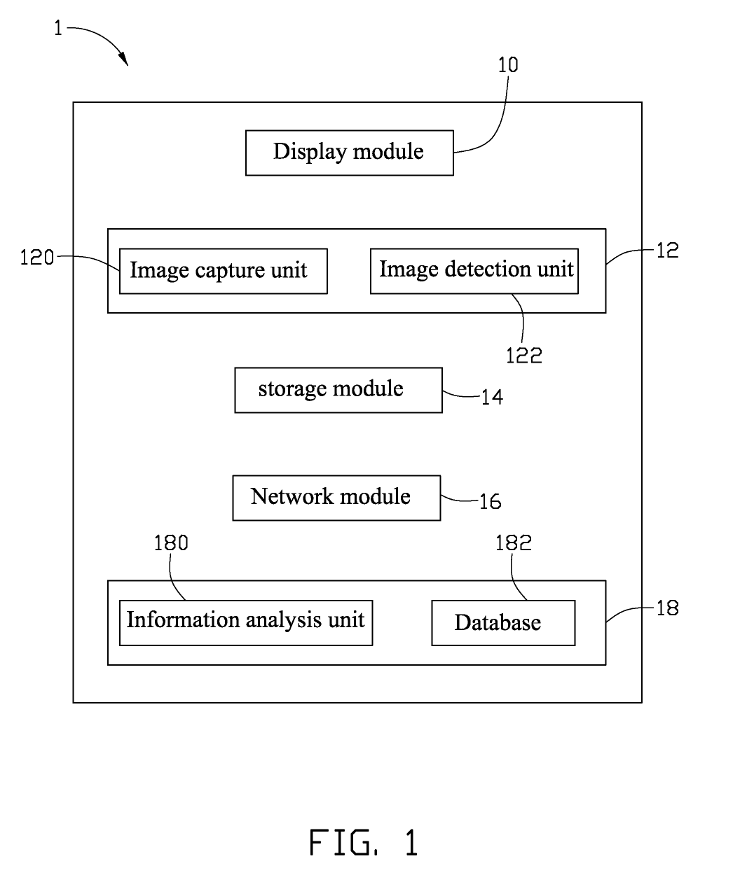

Referring to FIG. 1, a first embodiment of an information feedback system 1 includes a display module 10, an information acquisition module 12, a storage module 14, a network module 16, and a processing module 18. The information acquisition module 12 includes an image capture unit 120 and an image detection unit 122. The image capture unit 120 is a camera disposed on the display module 10. The processing module 18 is a host computer, which includes an information analysis unit 180 and a database 182.

The display module 10 is operable to display media content. The display module 10 may be an outdoor media. In one embodiment, the display module 10 is an electronic advertising billboard. The image capture unit 120 of the information acquisition module 12 is operable to capture images of viewers in front of the display module 10. The image detection unit 122 is to acquire information of the viewers according to the images captured by the image capture unit 120. The information of the viewers includes the number of the viewers and is stored in the storage module 14. The image detection unit 122 locates the faces of the viewers in the images captured by the image capture unit 120. The number of the viewers is obtained by counting the faces.

The information of the viewers may further include gender and ages of the viewers. The information about gender and ages of the viewers may be obtained by detecting and recognizing facial features of the viewers. In one embodiment, the information acquisition module 12 may read the information of the viewers whose images are captured at different times in a time period from the storage module 14, and transmit the information read from the storage module 14 to the information analysis unit 180 via the network module 16. In another embodiment, the information acquisition module 12 may transmit the acquired information of the viewers to the information analysis module 180 via the network module 16, without storing the information in the storage module 14.

The information analysis unit 180 is to process the information of the viewers, such as, obtaining an accumulated number of male viewers whose images are captured over a period of time. The accumulated number is stored in the database 182. The database 182 is operable to be read and written by the information analysis unit 180.

According to the above mentioned description, the processing module 18 is able to receive viewer information of outdoor media set in different places via the network module 16 for integrated analysis.

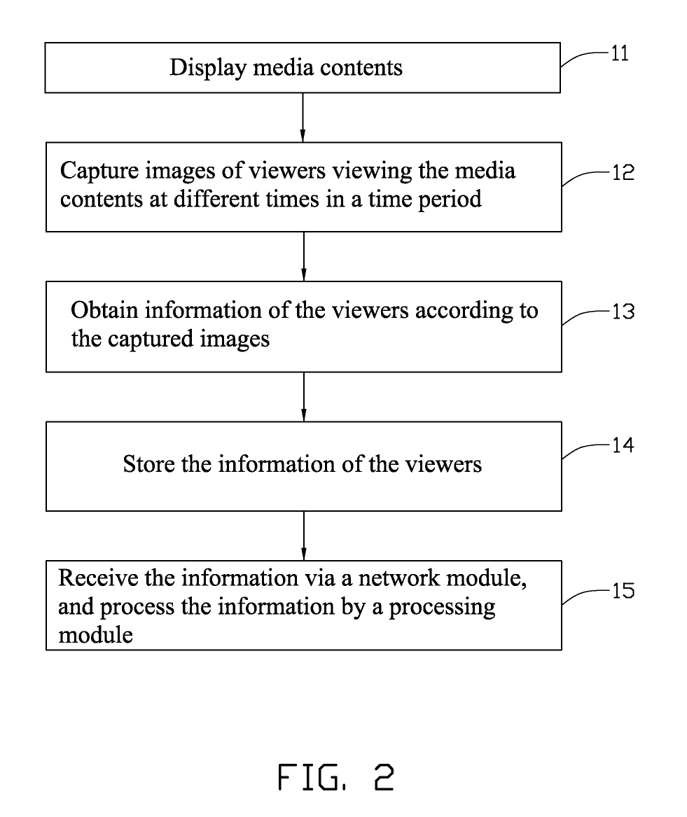

Referring to FIG. 2, a first embodiment of an information feedback method includes the following steps.

Step 11: display media content by the display module 10.

Step 12: capture images of viewers in front of the display module 10 at different times in a time period by the image capture unit 120.

Step 13: obtain information of the viewers by the image detection unit 122 according to the captured images. The information of the viewers includes the numbers of the viewers at the different times, and may also include information about gender and ages of the viewers. The image detection unit 122 locates the faces of the viewers in the captured images. The number of the viewers viewing the display module 10 at each of the different times is obtained by counting the faces.

Step 14: store the information of the viewers by the storage module 14.

Step 15: receive the information of the viewers from the information acquisition module 12 via the network module 16, and process the received information by the processing module 18. In this step, the numbers of the viewers, whose images are captured in the time period may be accumulated by the information analysis unit 180, to obtain the accumulated number. The accumulated number may be obtained by accumulating the numbers of the faces of all of the viewers, or the viewers being of same sexes or ages. The accumulated number is stored in the database 182. In one embodiment, the information of the viewers may be transmitted to the information analysis unit 180 after being read from the storage module 14. In other embodiments, the information of the viewers may be transmitted to the information analysis module 180 without being stored in the storage module 14.

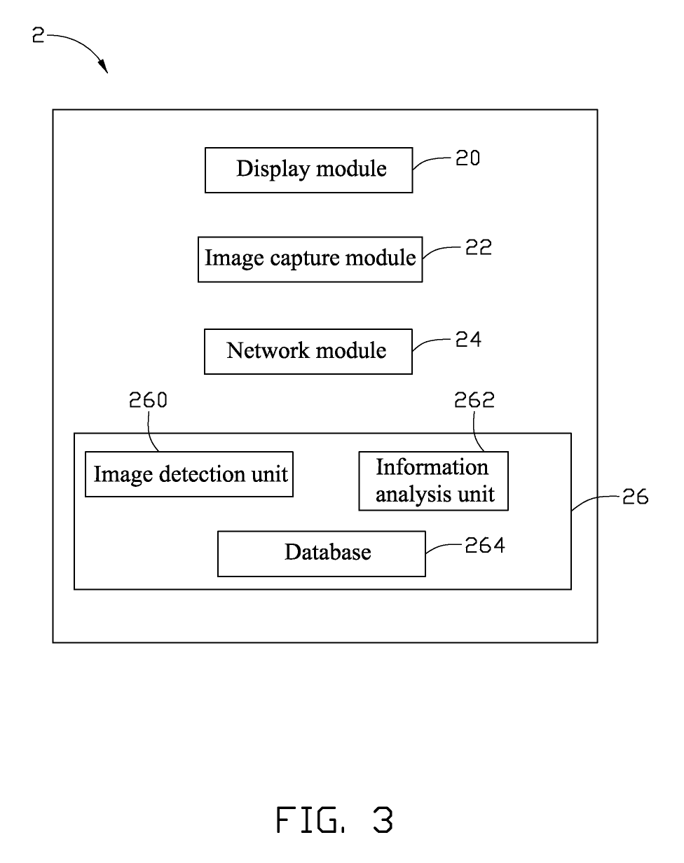

Referring to FIG. 3, a second embodiment of an information feedback system 2 includes a display module 20, an image capture module 22, a network module 24, and a processing module 26. In one embodiment, the display module 20 is an electronic billboard. The image capture module 22 is a camera disposed on the display module 20. The processing module 26 is a host computer, which includes an image detection unit 260, an information analysis unit 262, and a database 264.

The display module 20 is operable to display media content. The media content may be advertisement. The image capture module 22 is operable to capture images of viewers of the display module 20. The image detection unit 260 is to receive the captured images from the image capture module 22 via the network module 24. The image detection unit 260 obtains information of the viewers according to the received images. The information of the viewers includes the number of the viewers. The information of the viewers may also include the gender and age of each of the viewers. The image detection unit 260 locates the faces of the viewers in the received images. The number of the viewers is obtained by counting the faces.

The information analysis unit 262 is to process the information of the viewers, such as, obtaining an accumulated number of young people whose images are captured at different times in a period. The accumulated number is stored in the database 264. The database 264 is operable to be read and written by the information analysis unit 262.

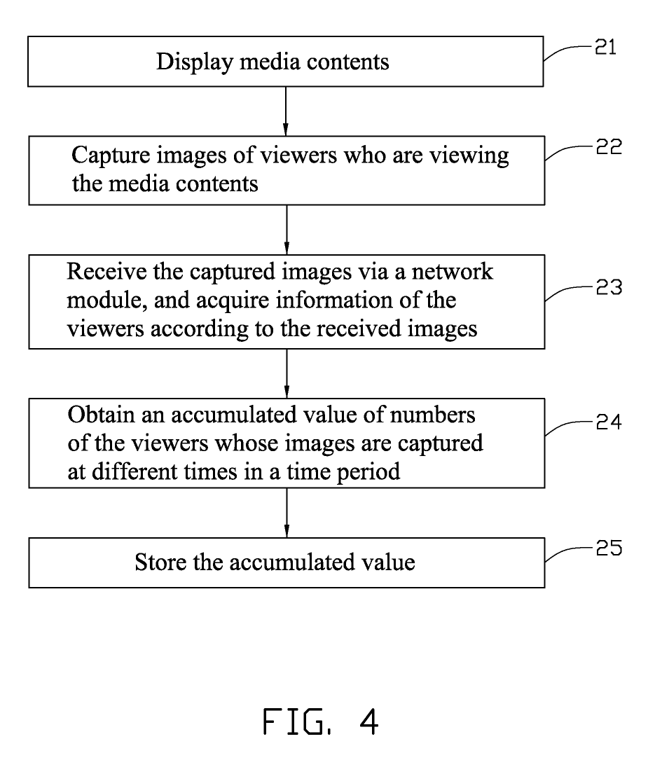

Referring to FIG. 4, a second embodiment of an information feedback method includes the following steps.

Step 21: display media content by the display module 20.

Step 22: capture images of viewers viewing the media contents by the image capture module 22.

Step 23: receive the captured images from the image capture module 22 via the network module 24, and obtain information of the viewers according to the received images by the image detection unit 260.

Step 24: obtain an accumulated number of the viewers whose images are captured in different times in a time period by the information analysis unit 262.

Step 25: store the accumulated number by the database 264.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. An information feedback system comprising:
a display module operable to display media content;
an information acquisition module operable to obtain numbers of viewers of the display module at different times in a time period;
a network module; and
a processing module operable to receive the viewer numbers via the network module, and obtain an accumulated number of the viewers.

2. The system of claim 1, wherein the display module is an outdoor media.

3. The system of claim 1, wherein the information acquisition module comprises an image capture unit operable to capture images of the viewers of the display module, and an image detection unit operable to obtain the viewer numbers according to the images captured by the image capture unit.

4. The system of claim 3, wherein the image capture unit is a camera disposed on the display module.

5. The system of claim 1, further comprising a storage module operable to store the numbers of the viewers.

6. The system of claim 1, wherein the processing module is a host computer which comprises an information analysis unit operable to obtain the accumulated value, and a database operable to store the accumulated number.

7. The system of claim 6, wherein the database is operable to be read and written by the information analysis unit.

8. An information feedback method comprising:
obtaining numbers of viewers viewing a display module at different times in a time period;
receiving the viewer numbers via a network by a processing module;
obtaining an accumulated value of the viewer numbers by the processing module.

9. The method of claim 8, wherein the step of obtaining the viewer numbers comprises:
capture images of the viewers viewing the display module at the different times by an image capture unit;
locating the viewer faces in the captured images by an image detection unit;
counting the viewer faces to obtain each of the viewer numbers by the image detection unit.

10. The method of claim 9, further comprising obtaining information about gender or ages of the viewers by detecting and recognizing facial features of the viewers by the image detection unit, wherein the accumulated value is obtained by accumulating the numbers of the faces of viewers being of same sexes or ages.

11. The method of claim 8, wherein the step of obtaining the viewer numbers further comprising:
storing each of the viewer numbers by a storage module; and
reading the viewer numbers from the storage module by the information acquisition module.

12. An information feedback method comprising:
capture images of viewers in front of a display module at different times in a time period by an image capture module;
receiving the captured images via a network by a processing module; and
obtaining an accumulated number of the viewers whose images are captured at the different times according to the received images by the processing module.

13. The method of claim 12, wherein the step of obtaining the accumulated number comprises obtaining images of the viewer faces by detecting and recognizing facial features of the viewers by an image detection unit, wherein each of the viewer numbers is obtained by counting the faces of viewers whose images are captured at one of the different times in the time period.

14. The method of claim 12, further comprising storing the accumulated number in a database.
